(19) United States
(12) Patent Application Publication
(10) Pub. No.: US 2009/0249371 A1
(43) Pub. Date: Oct. 1, 2009

(54) BUFFER ALLOCATION FOR NETWORK SUBSYSTEM

(76) Inventors: Omar Cardona, Austin, TX (US); James Brian Cunningham, Austin, TX (US); Baltazar De Leon, III, Austin, TX (US); Matthew Ryan Ochs, Austin, TX (US)

Correspondence Address: IBM Corp. (AUS/RCR);c/o The Rolnik Law Firm, P.C., 24 N. Main St., Kingwood, TX, 77339, US

(21) Appl. No.: 12/057,852

(22) Filed: Mar. 28, 2008

(51) Int. Cl. G06F 9/46

(52) U.S. Cl. 719/330

(57) ABSTRACT

The present invention provides a computer implemented method and apparatus for allocating communication buffers in a data processing system. The method comprises a streamlined mbuf pool service receiving a call from an I/O device driver, then determining if at least one mbuf linked list is empty. In response to a determination that at least one mbuf linked list is empty, the streamlined mbuf pool service calls an OS mbuf allocator to provide all mbufs in a second mbuf linked list, wherein the second mbuf linked list comprises a head of the second mbuf linked list. The streamlined mbuf pool service repopulates the second mbuf linked list, obtains a requested mbuf from the second mbuf linked list, and advances the head of the second mbuf linked list by at least one mbuf. The streamlined mbuf pool service then returns the requested mbuf to the I/O device driver, wherein the OS mbuf allocator allocates all mbufs in the second mbuf linked list.

### BACKGROUND OF THE INVENTION

1. Field of the Invention

The present invention relates generally to a computer implemented method, data processing system, and computer program product for allocating memory for communication functions. More specifically, the present invention relates to allocating buffers from a buffer pool in a memory locking environment.

2. Description of the Related Art

Computer systems frequently rely on network data connections to interoperate with other computers. Networked computers have been used in many architectures and business models. Data rates of common network elements are continuously being enhanced and redefined to meet new standards for speed and reliability. To satisfy higher data rate requirements, some computer architectures rely upon a network subsystem.

A network subsystem uses memory management facilities to provide readily available physical memory to buffer incoming and outgoing data streams. A unit of memory provided for this purpose is called an mbuf. An mbuf or memory buffer is used to store data in the kernel for incoming and outbound network traffic. Such memory always resides in physical memory and is never paged out.

A network service periodically needs to transport data. At this time, the network service can call an operating system mbuf allocator. An operating system mbuf allocator is a service that locks a pool of memory set aside for mbufs during a memory allocation operation. A buffer pool is one of one or more portions of memory set aside for networking operations. A call is an instruction and/or the act operation of a processor performing the instruction such that another block of code contains the next computer readable instruction. The OS (Operating System) mbuf allocator then obtains at least one mbuf, and unlocks the pool. An example of an OS mbuf allocator is the m_get( ) function of the AIX® operating system. AIX is a trademark of IBM Corporation.

The m_get( ) operating system mbuf allocator obtains an mbuf from a previously created mbuf linked list. An mbuf linked list is a linked list of nodes. Each node is a combination of a buffer and a link or a link alone. The mbuf linked list contains a set of mbufs that are within a pool that is lockable by the OS mbuf allocator. The OS mbuf allocator locks the pool regardless of whether the service request is for one mbuf or for all mbufs in an mbuf linked list. In addition, obtaining the mbuf is as much as about 70 machine level instructions. A lock is one or more bits that are associated with a tract of physical memory or other shared resource. The lock exists as either locked or unlocked, depending on the content of the one or more bits.

### SUMMARY OF THE INVENTION

The present invention provides a computer implemented method and apparatus for allocating communication buffers in a data processing system. The method comprises a streamlined mbuf pool service receiving a call from an I/O device driver, then determining if at least one mbuf linked list is empty. In response to a determination that at least one mbuf linked list is empty, the streamlined mbuf pool service calls an OS mbuf allocator to provide all mbufs in a second mbuf linked list, wherein the second mbuf linked list comprises a head of the second mbuf linked list. The streamlined mbuf pool service repopulates the second mbuf linked list, obtains a requested mbuf from the second mbuf linked list, and advances the head of the second mbuf linked list by at least one mbuf. The streamlined mbuf pool service then returns the requested mbuf to the I/O device driver, wherein the OS mbuf allocator allocates all mbufs in the second mbuf linked list.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a data processing system in accordance with an illustrative embodiment of the invention;

FIG. 2 is a diagram of software components that communicate in accordance with an illustrative embodiment of the invention;

FIG. 3 is a diagram of software components that communicate in accordance with another illustrative embodiment of the invention;

FIG. 4 is an mbuf linked list in accordance with an illustrative embodiment of the invention; and

FIG. 5A is a flowchart of an mbuf allocating process in accordance with an illustrative embodiment of the invention;

FIG. 5B is a flowchart of another mbuf allocating process in accordance with an illustrative embodiment of the invention; and

FIG. 5C is a flowchart of a support process that supports an mbuf allocating process in accordance with an illustrative embodiment of the invention.

### DETAILED DESCRIPTION OF THE PREFERRED EMBODIMENT

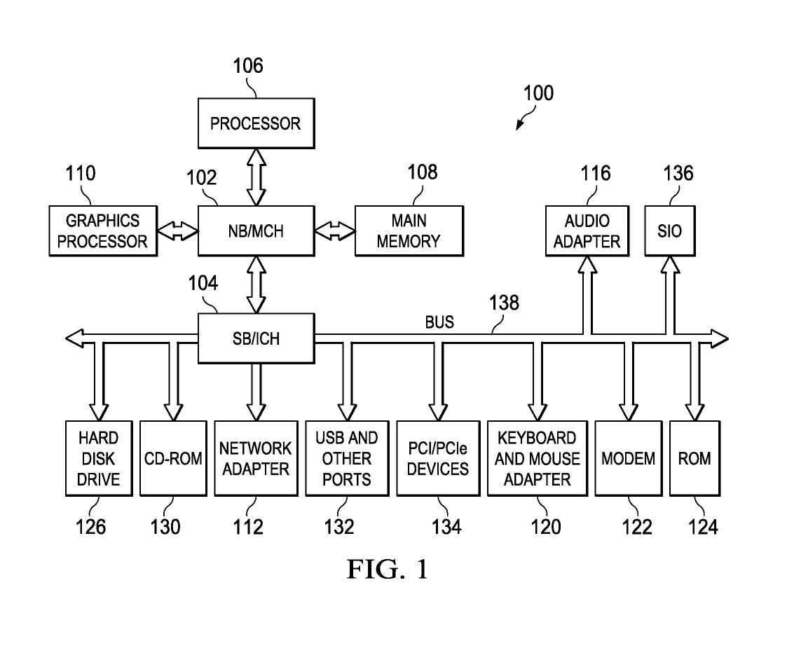

With reference now to the figures and in particular with reference to FIG. 1, a block diagram of a data processing system is shown in which aspects of an illustrative embodiment may be implemented. Data processing system 100 is an example of a computer, in which code or instructions implementing the processes of the present invention may be located. In the depicted example, data processing system 100 employs a hub architecture including a north bridge and memory controller hub (NB/MCH) 102 and a south bridge and input/output (I/O) controller hub (SB/ICH) 104. Processor 106, main memory 108, and graphics processor 110 connect to north bridge and memory controller hub 102. Graphics processor 110 may connect to the NB/MCH through an accelerated graphics port (AGP), for example.

In the depicted example, local area network (LAN) adapter 112 connects to south bridge and I/O controller hub 104 and audio adapter 116, keyboard and mouse adapter 120, modem 122, read only memory (ROM) 124, hard disk drive (HDD) 126, CD-ROM drive 130, universal serial bus (USB) ports and other communications ports 132, and PCI/PCIe devices 134 connect to south bridge and I/O controller hub 104 through bus 138 and bus 140. PCI/PCIe devices may include, for example, Ethernet adapters, add-in cards, and PC cards for notebook computers. PCI uses a card bus controller, while PCIe does not. ROM 124 may be, for example, a flash binary input/output system (BIOS). Hard disk drive 126 and CD-ROM drive 130 may use, for example, an integrated drive electronics (IDE) or serial advanced technology attachment (SATA) interface. A super I/O (SIO) device 136 may be connected to south bridge and I/O controller hub 104.

An operating system runs on processor 106 and coordinates and provides control of various components within data processing system 100 in FIG. 1. The operating system may be a commercially available operating system such as Microsoft® Windows® XP. Microsoft and Windows are trademarks of Microsoft Corporation in the United States, other countries, or both. An object oriented programming system, such as the Java™ programming system, may run in conjunction with the operating system and provides calls to the operating system from Java™ programs or applications executing on data processing system 100. Java™ is a trademark of Sun Microsystems, Inc. in the United States, other countries, or both.

Instructions for the operating system, the object-oriented programming system, and applications or programs are located on storage devices, such as hard disk drive 126, and may be loaded into main memory 108 for execution by processor 106. The processes of the present invention can be performed by processor 106 using computer implemented instructions, which may be located in a memory such as, for example, main memory 108, read only memory 124, or in one or more peripheral devices.

Those of ordinary skill in the art will appreciate that the hardware in FIG. 1 may vary depending on the implementation. Other internal hardware or peripheral devices, such as flash memory, equivalent non-volatile memory, and the like, may be used in addition to or in place of the hardware depicted in FIG. 1. In addition, the processes of the illustrative embodiments may be applied to a multiprocessor data processing system.

In some illustrative examples, data processing system 100 may be a personal digital assistant (PDA), which is configured with flash memory to provide non-volatile memory for storing operating system files and/or user-generated data. A bus system may be comprised of one or more buses, such as a system bus, an I/O bus and a PCI bus. Of course, the bus system may be implemented using any type of communications fabric or architecture that provides for a transfer of data between different components or devices attached to the fabric or architecture. A communication unit may include one or more devices used to transmit and receive data, such as a modem or a network adapter. A memory may be, for example, main memory 108 or a cache such as found in north bridge and memory controller hub 102. A processing unit may include one or more processors or CPUs. The depicted example in FIG. 1 is not meant to imply architectural limitations. For example, data processing system 100 also may be a tablet computer, laptop computer, or telephone device in addition to taking the form of a PDA.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order best to explain the principles of the invention and the practical application, and to enable others of ordinary skill in the art to understand the invention for various embodiments with various modifications as are suited to the particular use contemplated.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, for instance via, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The aspects of the illustrative embodiments provide a computer implemented method, data processing system, and computer program product for eliminating performance impacts that occur when obtaining buffers on an incremental basis. Instead, the embodiments aggregate allocation of buffers to the mbuf linked list level such that an mbuf pool lock is obtained once or fewer than once for each allocation of the many mbufs of a linked list.

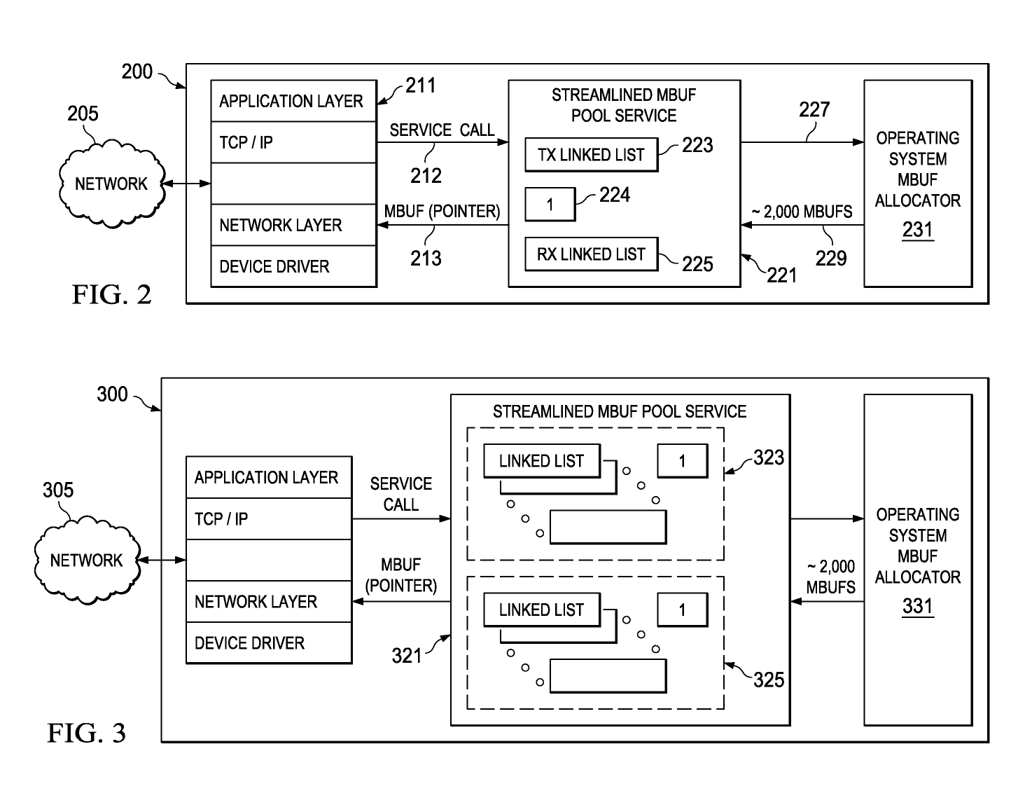

FIG. 2 shows a diagram of software components 200 that communicate in accordance with an illustrative embodiment of the invention. Protocol stack 211 may be a combination of kernel space and user-space software components that interact with network 205 to accomplish communication function. Protocol stack 211 communicates via service call 212 with streamlined mbuf pool service 221 to obtain an mbuf as a pointer 213 to each mbuf requested. Streamlined mbuf pool service 221, in turn, can make calls to OS mbuf allocator 231 to obtain mbuf linked lists, as needed. OS mbuf allocator 231 can be, for example, a modified m_get( ) function. The modified m_get( ) function is modified to determine a number of mbufs requested, and in response thereto, provide, to the extent available, the number of mbufs requested. The OS mbuf allocator iteratively references the pointer of one node to the content of a subsequent node to create the list.

Streamlined mbuf pool service 221 can obtain one mbuf linked list at a time from OS mbuf allocator 231. For example, streamlined mbuf pool service 221 can obtain mbuf linked list 223 and mbuf linked list 225 derived from a common pool or buffer pool of linked lists. Each of these linked lists may be allocated to transmit functions or receive functions, respectively, of protocol stack 211. The pool of linked lists may have an associated lock, for example, lock 224. A call from streamlined mbuf pool service 221 to OS mbuf allocator 231 may begin with streamlined mbuf pool service 221 making a request to obtain mbufs 227. Unlike the m_get( ) function of the prior art, OS mbuf allocator 231, may respond to such a request by providing a link 229 to mbuf linked list having multiple mbufs. OS mbuf allocator 231 may toggle lock 224 to accordingly protect mbufs while OS mbuf allocator 231 creates the mbuf linked list.

FIG. 3 is a diagram of software components that communicate through network 305 in accordance with another illustrative embodiment of the invention. Streamlined mbuf pool service 321 operates with at least one non-empty mbuf linked list for each of the transmit linked list and the receive linked list while operating in a steady state. Mbuf linked lists associated with the transmit function are available as a pool of at least two mbuf linked lists, known as a transmit pool. For example, software components 300 may rely on transmit pool 323 for the transmit operations, and pool 325 for receive operations. Accordingly, an extended interval may be permissible between one of the mbuf linked lists becoming empty and OS mbuf allocator 331 providing a non-empty mbuf linked list to replace the empty mbuf linked list.

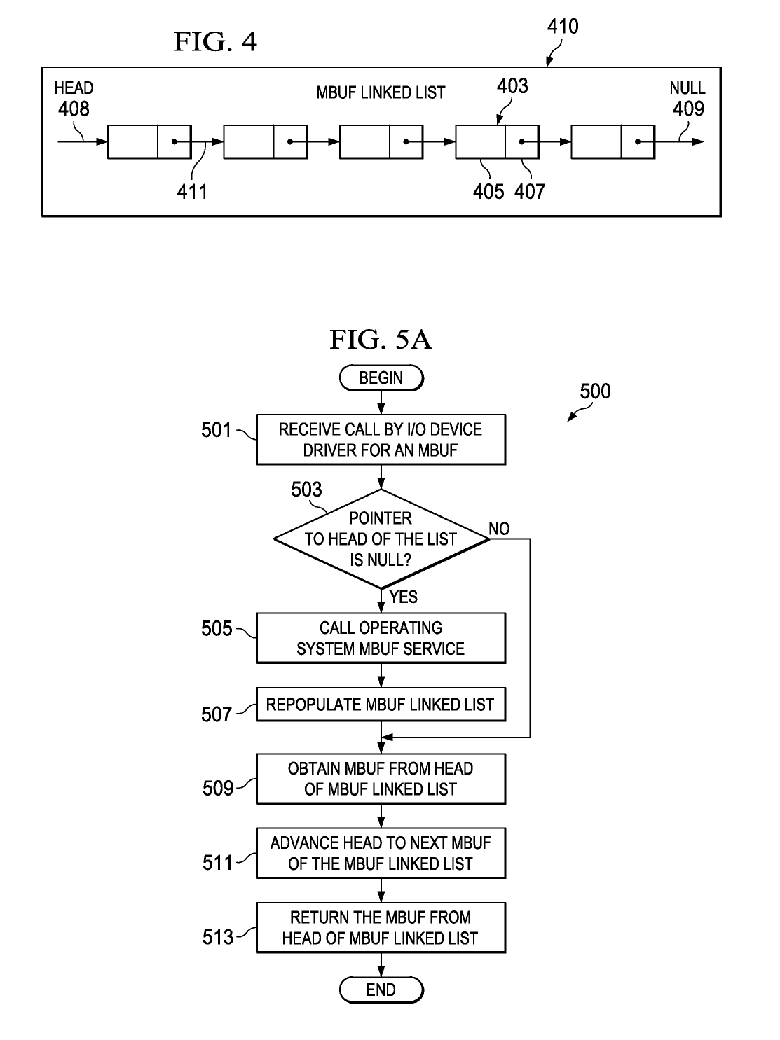

FIG. 4 is an mbuf linked list in accordance with an illustrative embodiment of the invention. Mbuf linked list 410 comprises at least one node pointed to by head 408. The mbuf linked list can consist of, for example, 512 mbufs or more. A head is a pointer to a first node in a set of at least one node of an mbuf linked list. A next packet may be pointed to by pointer 411. A variable that stores pointer 411 may be named “m_nextpkt.” A node, such as node 403 can include memory buffer or mbuf 405 and a link 407. A link from one mbuf to a second mbuf may be referenced with the nomenclature: mbuf→m_nextpkt. In computer instructions that reference such a link, or next packet, the ‘mbuf’ is a name or other reference of the one mbuf, while ‘mbuf→m_nextpkt’ refers to the second mbuf. Accordingly, within a context of an mbuf, the m_nextpkt is the pointer to a next packet in the linked list. In addition, a node can be null 409. The null node can be the node that head 408 points to when mbuf linked list 410 becomes empty.

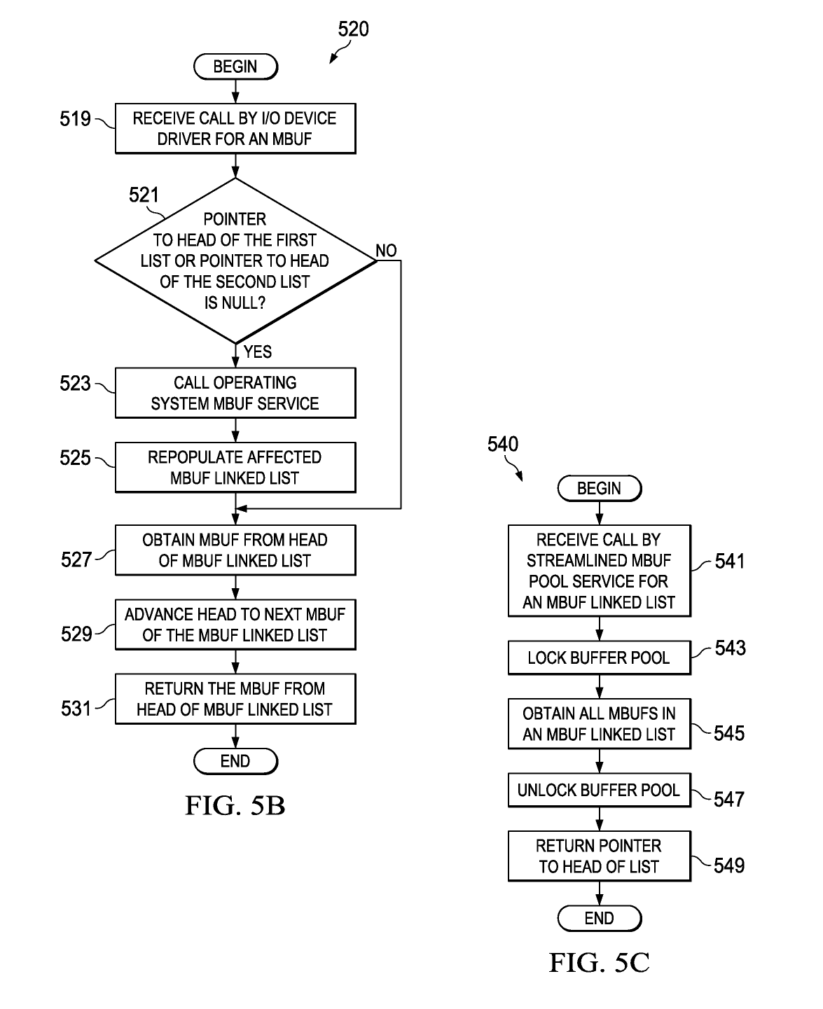

FIG. 5A is a flowchart of an mbuf allocating process in accordance with an illustrative embodiment of the invention. Method 500 may correspond with software components 200 of FIG. 2. Initially, a streamlined mbuf pool service receives a call by an I/O device driver for an mbuf (step 501). An I/O device driver is computer instructions operating on one or more processors that permit a matching physical device to provide communication functions to other software components, for example, a logical partition. The I/O device driver may be I/O device driver of protocol stack 211 in FIG. 2 and the matching physical device may be network adapter 112 of FIG. 1. Next, the streamlined mbuf pool service determines if the mbuf linked list is empty. For example, the streamlined mbuf pool service may determine if the pointer to the head of the list is null (step 503). If the head is null, the streamlined mbuf pool service calls the OS mbuf allocator service (step 505). Next, the streamlined mbuf pool service repopulates the mbuf linked list (step 507).

However, a negative result to step 503 causes steps 505 and 507 to be skipped. Accordingly, the streamlined mbuf pool service next obtains a requested mbuf from the head of the mbuf linked list (step 509). A requested mbuf is an mbuf that is referenced by the head associated with the mbuf linked list. Next, the streamlined mbuf pool service advances the head to the next mbuf of the mbuf linked list (step 511). Next, the streamlined mbuf pool service may return the mbuf from the head of the mbuf linked list to the I/O device driver (step 513). Processing terminates thereafter.

The call to the operating system (OS) mbuf allocator may be a call to m_get( ). However, it is appreciated that other operating system mbuf allocators may be equally well suited to perform the function of obtaining one or more mbufs in a linked list by locking out access for the linked list while obtaining the linked list.

FIG. 5B is a flowchart of another mbuf allocating process in accordance with an illustrative embodiment of the invention. Method 520 may correspond with software components 300 of FIG. 3. Initially, a streamlined mbuf pool service receives a call by an I/O device driver for an mbuf (step 519). Next, the streamlined mbuf pool service determines if at least one mbuf linked list is empty. The streamlined mbuf pool service may perform this step, for example, by determining if a pointer to a head of a first list or a pointer to a head of a second list is null (step 521).

If one of the first list or second list is null or empty, the streamlined mbuf pool service calls the OS mbuf allocator service to obtain a replacement mbuf linked list (step 523). Next, the streamlined mbuf pool service repopulates the affected mbuf linked list (step 525). The affected mbuf linked list is the one or more mbuf linked lists that were determined to be empty at step 521. If neither the first list nor the second list is null, step 521 will cause the streamlined mbuf pool service to obtain an mbuf from the head of an mbuf linked list (step 527). Next, the streamlined mbuf pool service advances the head to the next mbuf of the mbuf linked list (step 529). Next, the streamlined mbuf pool service may return the mbuf from the head of the mbuf linked list to the I/O device driver (step 531). Processing terminates thereafter.

FIG. 5C is a flowchart of a support process that supports an mbuf allocating process in accordance with an illustrative embodiment of the invention. A streamlined mbuf pool service as described in FIGS. 5A and 5B may call to an operating system (OS) mbuf allocator. Accordingly, the steps of FIG. 5C may be performed in an OS mbuf allocator software component, such as, for example, OS mbuf allocator 231 and OS mbuf allocator 331, of FIGS. 2 and 3, respectively. Initially, OS mbuf allocator receives a call by streamlined mbuf pool service for an mbuf linked list (step 541).

Next, OS mbuf allocator locks a buffer pool that hosts at least one mbuf linked list (step 543). Next, the OS mbuf allocator obtains all mbufs in an mbuf linked list of the pool (step 545). Next, the OS mbuf allocator unlocks the buffer pool (step 547). Next, the OS mbuf allocator returns a pointer to head to the streamlined mbuf pool service (step 549). Processing terminates thereafter.

Although the steps of method 540 may be performed by OS mbuf allocator, it is appreciated that the streamlined mbuf pool service may perform the steps of method 540 in some embodiments of the invention. In addition, regardless of the software component performing steps of method 540, the steps may be performed as a thread distinct from a thread of instructions of the calling routine. Thus, the steps may be performed in a second thread. A thread is a thread of execution that allows a program or other computer instructions to split instruction execution. By splitting instruction execution, the program allows each thread of instructions to be performed simultaneously or contemporaneously.

The illustrative embodiments enable a reduction in instructions performed when requesting allocations of buffers for networking functions. For example, rather than applying for additional buffers on a granular level and preserving free mbufs in a pool, the embodiments aggregate the allocation process to incur locks based on mbuf allocations only for an instance of obtaining all mbufs within a linked list.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for allocating communication buffers in a data processing system, the method comprising:
receiving a call from an I/O device driver;
determining if at least one mbuf linked list is empty;
responsive to a determination that the at least one mbuf linked list is empty, calling an OS mbuf allocator to provide all mbufs in a second mbuf linked list, wherein the second mbuf linked list comprises a head of the second mbuf linked list;
repopulating the second mbuf linked list;
obtaining a requested mbuf from the second mbuf linked list;
advancing the head of the second mbuf linked list by at least one mbuf; and
returning the requested mbuf to the I/O device driver, wherein the OS mbuf allocator allocates all mbufs in the second mbuf linked list.

2. The computer implemented method of claim 1, wherein the receiving step and the determining step occur on a first thread, and provision of all mbufs in a second mbuf linked list occurs on a second thread.

3. The computer implemented method of claim 2, wherein all mbufs in the second mbuf linked list are greater than two mbufs, and the step of advancing the head of the second mbuf linked list does not incur a lock on a buffer pool.

4. The computer implemented method of claim 2, wherein the operating system mbuf allocator locks a buffer pool only once per step of calling the OS mbuf allocator.

5. The computer implemented method of claim 2, wherein the at least one mbuf linked list is one mbuf linked list having at least two nodes.

6. The computer implemented method of claim 1, wherein all mbufs in the second mbuf linked list are greater than two mbufs.

7. The computer implemented method of claim 1, wherein the operating system mbuf allocator locks a buffer pool only once per call to the OS mbuf allocator.

8. A computer program product for allocating communication buffers in a data processing system, the computer program product comprising:
a computer usable medium having computer usable program code embodied therewith, the computer program product comprising:
computer usable program code configured to receive a call from an I/O device driver;
computer usable program code configured to determine if at least one mbuf linked list is empty;
computer usable program code, responsive to a determination that the at least one mbuf linked list is empty, configured to call an OS mbuf allocator to provide all mbufs in a second mbuf linked list, wherein the second mbuf linked list comprises a head of the second mbuf linked list;
computer usable program code configured to repopulate the second mbuf linked list;
computer usable program code configured to obtain a requested mbuf from the second mbuf linked list;
computer usable program code configured to advance the head of the second mbuf linked list by at least one mbuf; and
computer usable program code configured to return the requested mbuf to the I/O device driver, wherein the OS mbuf allocator allocates all mbufs in the second mbuf linked list.

9. The computer program product of claim 8, wherein the computer usable program code configured to receive and the computer usable program code configured to determine operates on a first thread, and the provision of all mbufs in a second mbuf linked list operates on a second thread.

10. The computer program product of claim 9, wherein all mbufs in the second mbuf linked list are greater than two mbufs, and the computer usable program code configured to advance the head of the second mbuf linked list does not incur a lock on a buffer pool.

11. The computer program product of claim 9, wherein the operating system mbuf allocator locks a buffer pool only once during operation of computer usable program code configured to call the OS mbuf allocator.

12. The computer program product of claim 9, wherein the at least one mbuf linked list is one mbuf linked list having at least two nodes.

13. The computer program product of claim 8, wherein all mbufs in the second mbuf linked list are greater than two mbufs.

14. The computer program product of claim 8, wherein the operating system mbuf allocator locks a buffer pool only once per operation of computer usable program code configured to call to the OS mbuf allocator.

15. A data processing system comprising:
a bus;
a storage device connected to the bus, wherein computer usable code is located in the storage device;
a communication unit connected to the bus;
a processing unit connected to the bus, wherein the processing unit executes the computer usable code for allocating communication buffers in a data processing system, wherein the processing unit executes the computer usable program code to receive a call from an I/O device driver; determine if at least one mbuf linked list is empty; responsive to a determination that the at least one mbuf linked list is empty, call an OS mbuf allocator to provide all mbufs in a second mbuf linked list, wherein the second mbuf linked list comprises a head of the second mbuf linked list; repopulate the second mbuf linked list; obtain a requested mbuf from the second mbuf linked list; advance the head of the second mbuf linked list by at least one mbuf; and return the requested mbuf to the I/O device driver, wherein the OS mbuf allocator allocates all mbufs in the second mbuf linked list.

16. The data processing system of claim 15, wherein the computer usable program code configured to receive and the computer usable program code configured to determine operates on a first thread, and computer usable program code to provide all mbufs in a second mbuf linked list operates on a second thread.

17. The data processing system of claim 16, wherein all mbufs in the second mbuf linked list are greater than two mbufs, and the computer usable program code configured to advance the head of the second mbuf linked list does not incur a lock on a buffer pool.

18. The data processing system of claim 16, wherein the operating system mbuf allocator locks a buffer pool only once during operation of computer usable program code configured to call the OS mbuf allocator.

19. The data processing system of claim 16, wherein the at least one mbuf linked list is one mbuf linked list having at least two nodes.

20. The data processing system of claim 15, wherein all mbufs in the second mbuf linked list are greater than two mbufs.
